(19) United States
(12) Patent Application Publication
(10) Pub. No.: US 2026/0304028 A1
(43) Pub. Date: Oct. 1, 2026

(54) AUDIO DEVICE WITH PRESSURE EQUALIZATION

(71) Applicant: Tymphany HK Limited, Wanchai (HK)

(72) Inventors: Garry David TAYLOR, Taipei City (TW); Gavin Jones, Taipei City (TW)

(21) Appl. No.: 19/575,565

(22) Filed: Mar. 23, 2026

Related U.S. Application Data
(60) Provisional application No. 63/777,138, filed on Mar. 25, 2025.

(51) Int. Cl. H04R 1/28; H04R 1/02; H04R 7/12; H04R 9/02

(52) U.S. Cl. CPC H04R 1/2811; H04R 1/023; H04R 7/12; H04R 9/025

(57) ABSTRACT

An audio device includes an enclosure, an acoustic transducer, and a semi-permeable membrane assembly. The enclosure defines a sealed internal volume and has an exterior opening. The acoustic transducer is secured to the enclosure and includes a magnetic motor assembly with a motor vent. A ventilation structure is defined between the motor vent and the exterior opening to establish gas communication with an ambient environment. The semi-permeable membrane assembly is positioned at a gas outlet of the ventilation structure. Optionally, an extension tube is provided to connect the motor vent to the exterior opening. The semi-permeable membrane assembly permits controlled gas exchange for pressure equalization while blocking ingress of liquid and contaminants.

### CROSS REFERENCE TO RELATED APPLICATIONS

This application claims priority of U.S. Provisional Application No. 63/777,138 filed on Mar. 25, 2025 under 35 U.S.C. § 119(e), the entire contents of which are hereby incorporated by reference.

### BACKGROUND OF THE INVENTION

### Field of the Invention

The present disclosure relates generally to acoustic devices and, more particularly, to an audio device having an improved pressure equalization structure for a sealed acoustic enclosure.

### Description of Related Art

In portable audio devices having sealed enclosures, pressure differentials commonly arise between an interior of the enclosure and the ambient environment due to temperature fluctuations or altitude changes. Such pressure imbalances can degrade acoustic performance, including increased distortion, reduced acoustic output efficiency, and additional mechanical loading on internal components, thereby adversely affecting device reliability and operational lifespan.

To address the foregoing issues, various pressure equalization solutions have been proposed, such as providing gas release paths within the device structure. However, simple open-vent designs often increase the risk of liquid or debris ingress into the device, which may result in damage to electronic components. Some approaches attempt to improve protection by incorporating elements having semi-permeable characteristics. Nevertheless, in practical applications, such structures remain susceptible to blockage caused by external water droplets or accumulated debris, thereby degrading ventilation performance and diminishing pressure equalization effectiveness over time. Furthermore, In some implementations, pressure equalization structures are positioned close to moving acoustic components, which may introduce additional acoustic loading or airflow interference. This can adversely affect diaphragm motion characteristics and reduce overall acoustic fidelity.

Accordingly, existing pressure equalization solutions continue to present limitations in terms of acoustic performance, liquid resistance, spatial integration, and manufacturability. For these reasons, there remains a need for an improved pressure equalization structure that effectively balances internal and external pressure while maintaining sound quality and reducing the risk of liquid or debris blockage.

### BRIEF SUMMARY OF THE INVENTION

To address these issues, the present disclosure provides an audio device including a controlled ventilation structure that enables gas exchange between the interior of the enclosure and the ambient environment while preventing ingress of liquid, dust, or other contaminants.

In one aspect, an audio device includes an enclosure defining a sealed internal volume. A first opening is formed on a first surface of the enclosure and a second opening is formed on a second surface of the enclosure. An acoustic transducer including a diaphragm and a magnetic motor assembly is mounted to the first opening such that the diaphragm is exposed through the first opening. The magnetic motor assembly includes a motor vent extending through the motor structure.

A ventilation structure is defined between the motor vent and the second opening of the enclosure, thereby establishing gas communication between the sealed internal volume and the exterior of the enclosure.

A semi-permeable membrane assembly is positioned at an outlet of the ventilation structure. The semi-permeable membrane assembly permits gas exchange for pressure equalization while substantially blocking the ingress of liquids and contaminants.

In certain embodiments, the audio device may further include an extension tube coupled between the motor vent and the second opening of the enclosure. Optionally, the extension tube may include a straight section, curved section, or flared section to optimize airflow characteristics and structural integration within the enclosure.

In some embodiments, the semi-permeable membrane assembly includes a support frame supporting a gas-permeable membrane, such as an expanded polytetrafluoroethylene (ePTFE) membrane or other fluoropolymer membrane having hydrophobic properties.

In another aspect, the present disclosure provides a ventilation module that can be integrated into an audio device to provide pressure equalization while maintaining environmental sealing.

In yet another aspect, a method is provided for equalizing pressure in an audio device by forming a ventilation path between a motor vent of an acoustic transducer and an exterior of the enclosure and disposing a semi-permeable membrane at an outlet of the ventilation path.

Through the above configuration, the disclosed structures effectively balance internal and external pressure while maintaining protection against water and contaminants, thereby improving acoustic stability, device reliability, and operational durability.

The disclosed structure improves pressure equalization efficiency while maintaining acoustic performance. By routing the ventilation path through the motor vent of the magnetic motor assembly and positioning the semi-permeable membrane at an external outlet, the structure reduces acoustic interference with diaphragm movement while maintaining protection against liquid and contaminants.

### BRIEF DESCRIPTION OF THE DRAWINGS

The invention can be more fully understood by reading the subsequent detailed description and examples with references made to the accompanying drawings, wherein:

FIG. 1 is a perspective cutaway view of an audio device according to one embodiment of the present invention, showing an acoustic transducer disposed within an enclosure and a semi-permeable membrane assembly arranged at an outlet of a motor vent of a magnetic motor assembly.

FIG. 2 is a perspective view of one embodiment of the semi-permeable membrane assembly of the present invention, showing a modular configuration in which a semi-permeable membrane is disposed in a central region of an annular support frame.

FIG. 3 is a perspective view of another embodiment of the semi-permeable membrane assembly, showing that the annular support frame further includes a sealing structure to enhance sealing performance and fixation stability.

FIG. 4 is a perspective cutaway view of another embodiment of the present invention, showing that an extension tube is disposed between the motor vent of the magnetic motor assembly and the semi-permeable membrane assembly.

FIG. 5 is a perspective view of yet another embodiment of the semi-permeable membrane assembly, showing that the annular support frame is formed in a cap-like structure.

FIG. 6 is a schematic cross-sectional view of an acoustic device according to one embodiment of the present invention, showing that the semi-permeable membrane assembly is sleeved over an end portion of the extension tube.

FIG. 7 is a schematic cross-sectional view of another embodiment of the present invention, showing that the extension tube forms in a different shape toward a side wall of the enclosure.

FIG. 8 is a schematic cross-sectional view of a further embodiment of the present invention, showing that the extension tube forms a flared structure.

FIG. 9 is a schematic cross-sectional view of another embodiment of the present invention, showing that a flange at one end of the extension tube is joined to the magnetic motor assembly.

FIG. 10 is a schematic cross-sectional view of another embodiment of the present invention, showing that an alternative structural configuration of the enclosure and the extension tube.

### DETAILED DESCRIPTION OF THE INVENTION

The following detailed description illustrates exemplary embodiments of the present disclosure with reference to the accompanying drawings. The embodiments described herein are intended to illustrate the principles of the invention and are not intended to limit the scope of the invention.

For clarity, identical or similar reference numerals may be used to indicate identical or similar structural elements in different embodiments.

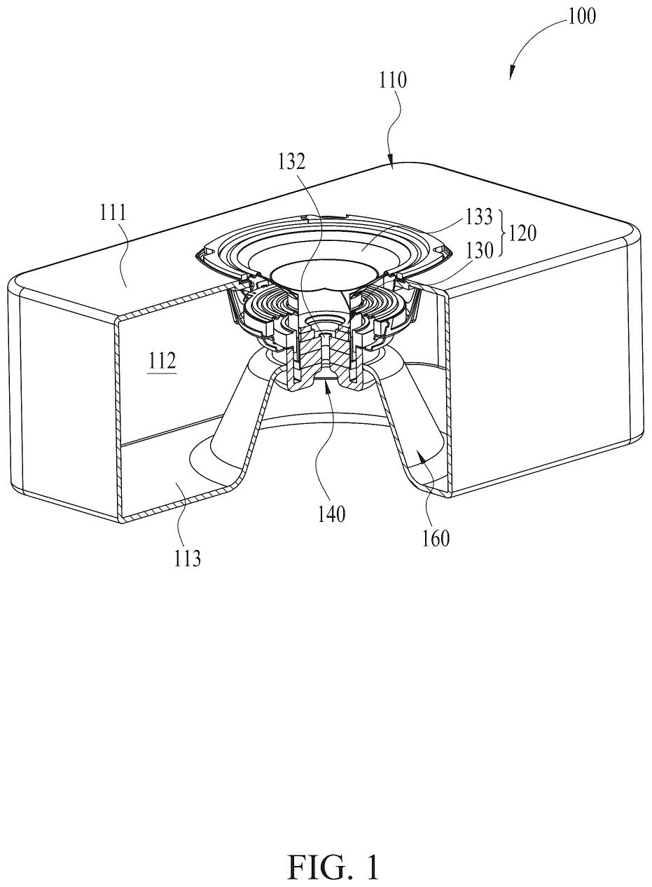

Referring to FIG. 1, an audio device 100 according to one embodiment is illustrated. The audio device 100 includes an enclosure 110 that defines a sealed internal volume. The enclosure 110 may be formed from a suitable rigid structural material such as wood, metal, engineering plastic, composite material, or combinations thereof.

As illustrated in FIG. 1, a first opening (receiving opening) is formed on a first surface 111 of the enclosure 110. An acoustic transducer 120 is mounted and secured to the first opening. The acoustic transducer 120 includes a diaphragm 133 and a magnetic motor assembly 130 configured to drive the diaphragm 133. The magnetic motor assembly 130 may, for example, include a yoke, a magnet, a center pole, and a top plate (not shown), which together form a complete magnetic circuit structure for the driving. The diaphragm 133 is exposed through the first opening so that acoustic waves generated by the diaphragm 133 may propagate outside the enclosure 110.

A motor vent 132 extends through the magnetic motor assembly 130 to provide an air passage through the central region of the magnetic motor assembly 130.

As illustrated in FIG. 1, the enclosure 110 includes a second opening (exterior opening) formed on a second surface 113. The peripheral edge of the second opening sealingly surrounds the outer periphery of the magnetic motor assembly 130, exposing the outlet of the motor vent 132 to the exterior. To ensure airtight integrity, a sealing member may be provided between the magnetic motor assembly 130 and the enclosure 110. Accordingly, the motor vent 132 establishes direct gas communication with the external environment, thereby providing an effective gas exchange pathway.

In this embodiment, the enclosure 110 includes a recessed portion 160 extending inwardly toward the magnetic motor assembly 130. In certain implementations, the transverse cross-sectional inner diameter of the recessed portion 160 may gradually increase from the second opening toward an exterior direction. This outwardly expanding geometry may reduce airflow resistance and improve gas exchange efficiency.

A ventilation structure is formed between the motor vent 132 and the second opening on the second surface 113 of the enclosure 110. The ventilation structure establishes a gas communication path between the sealed internal volume 112 and the exterior environment. A semi-permeable membrane assembly 140 is positioned to traverse a gas outlet of the ventilation structure. The semi-permeable membrane assembly 140 permits gas exchange while substantially blocking ingress of liquid and contaminants.

In various embodiments, the ventilation structure may be defined directly between the motor vent and the second opening of the enclosure, or may include additional intermediate conduits, channels, or cavities forming a continuous airflow path.

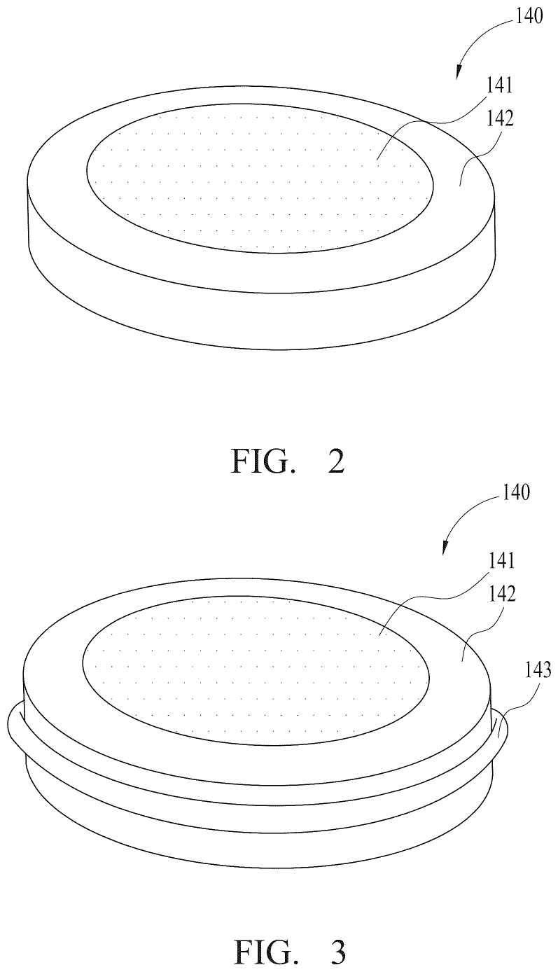

As shown in FIG. 2, the assembly 140 typically comprises a semi-permeable membrane 141 secured within an annular support frame 142. In certain embodiments, the semi-permeable membrane assembly 140 is only the semi-permeable membrane 141, and the semi-permeable membrane 141 is fitted with the magnetic motor assembly 130 to traverse a gas outlet of the ventilation structure. Alternatively, the annular support frame 142 may be designed to fit with the magnetic motor assembly 130, and the semi-permeable membrane 141 is secured within the annular support frame 142.

As illustrated in FIG. 3, the assembly 140 may include a sealing member 143 disposed on the outer periphery of the annular support frame 142 to ensure airtight engagement with the magnetic motor assembly 130. The sealing member 143 may comprise an O-ring, a sealing ring, a rubber gasket, a foam gasket, or other components having elastic sealing properties, or any combination thereof. In certain embodiments, the annular support frame 142 and the sealing member 143 may be formed as an integrally molded component, for example formed as a single piece using a material having elastic sealing properties, such that both supporting and sealing functions are provided simultaneously, while reducing the number of components and simplifying the assembly process. Optionally, the semi-permeable membrane 141, the annular support frame 142, and the sealing member 143 are integrated to form a unified modular structure. The semi-permeable membrane assembly 140 may be directly inserted into and secured at the outlet of the motor vent 132.

In certain embodiments, the semi-permeable membrane 141 may include a multilayer membrane structure, for example including at least an expanded polytetrafluoroethylene (ePTFE) film or an equivalent fluoropolymer film, with hydrophobic surfaces formed on opposite sides thereof, such that the semi-permeable membrane assembly 140 exhibits hydrophobic properties on both sides. The membrane 141 may be treated to be hydrophobic on both surfaces. For additional durability, an outer protective mesh or microporous overlay can be included to shield the membrane from physical damage. A protective mesh or a microporous overlay (not shown) may be disposed on an outer side of the semi-permeable membrane 141 to prevent foreign objects from directly impacting the surface of the semi-permeable membrane 141. Furthermore, a shape, thickness, porosity, or effective air-permeable area of the semi-permeable membrane 141 may be adjusted according to different acoustic requirements and protection ratings, so as to be applicable to acoustic transducer devices of different sizes or power levels.

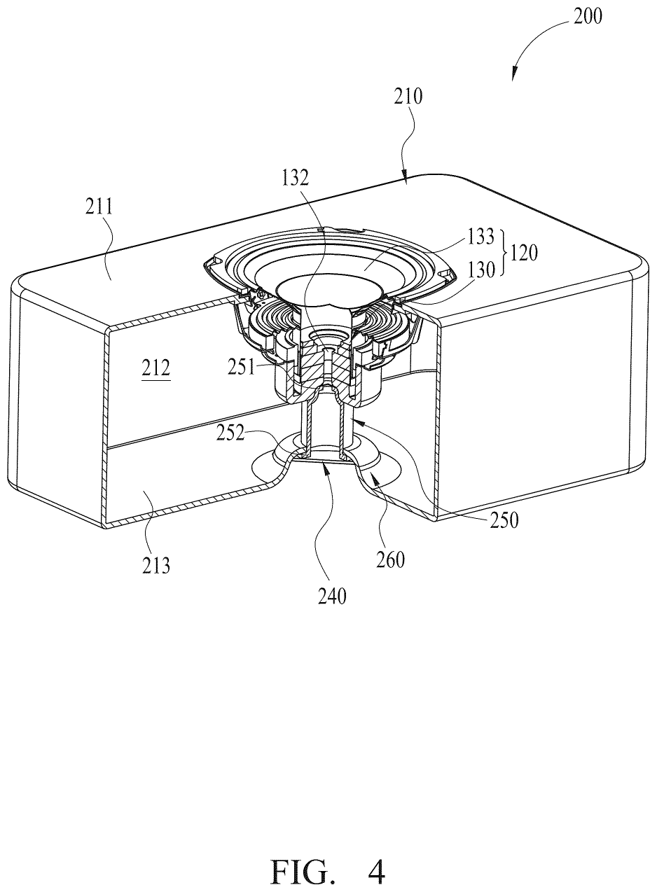

Referring to FIG. 4, an audio device 200 according to another embodiment is illustrated. To enhance configuration flexibility, the audio device 200 may further include an extension tube 250 for defining another embodiment of the ventilation structure.

The audio device 200 includes an enclosure 210 defining a sealed internal volume 212 and an acoustic transducer 120 mounted and sealed to a first opening on the first surface 211. In this embodiment, the extension tube 250 has a first end 251 coupled to the motor vent 132 and a second end 252 coupled to the second opening on the second surface 213 of the enclosure 210. As illustrated in FIG. 4, a protruding portion at the first end 251 may be sleeved over of the motor vent 132. In a transverse cross-section, the inner diameter of the protruding portion of the first end 251 gradually increases outwardly from the motor vent opening 132, thereby providing a diffusive guiding effect for airflow exiting the extension tube 150.

Furthermore, in a different embodiment, a protruding portion at the first end 251 may be sleeved within the motor vent 132, not shown. The shape of the protruding portion may be varied according to the engagement between the magnetic motor assembly 130 and the extension tube 250, such that the extension tube 250 connects the motor vent 132 of the magnetic motor assembly 130 to the second opening of the enclosure 210. By extending the ventilation path away from the motor vent, the extension tube may reduce acoustic interference, provide improved airflow control, and allow flexible routing within compact device structures.

In this embodiment, the second surface 213 includes a recessed portion 260, and the second opening is in the recessed portion 260. The second end 252 of the extension tube 250 is exposed to the exterior through the second opening on the second surface 213 of the enclosure 210. The peripheral edge of the second opening sealingly surrounds an outer periphery of the second end 252 of the extension tube 250, such that the motor vent 132 is placed in gas communication with the external environment.

In this embodiment, a semi-permeable membrane assembly 140 is positioned at the second end 252 of the extension tube 250 to traverse the gas outlet of the ventilation structure.

In certain embodiments, the second end 252 of the extension tube 250 further includes a flange, wherein a surrounding region of the second opening of the recessed portion 260 abuts upper side of the flange, and a surrounding region of the semi-permeable membrane assembly 140 abuts the bottom side of the flange, thereby providing axial clamping engagement of the extension tube 250. Such configuration enhances the engagement strength among the extension tube 250, the recessed portion 260, and the semi-permeable membrane assembly 140, as well as overall structural stability.

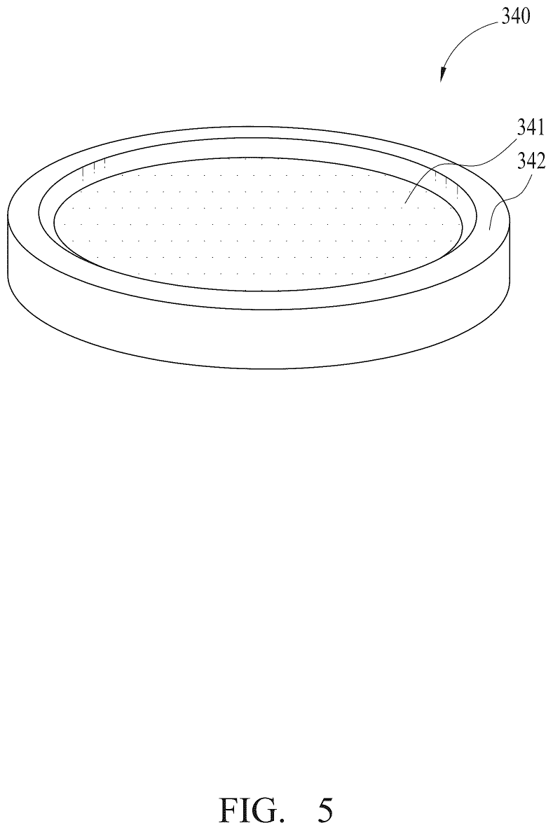

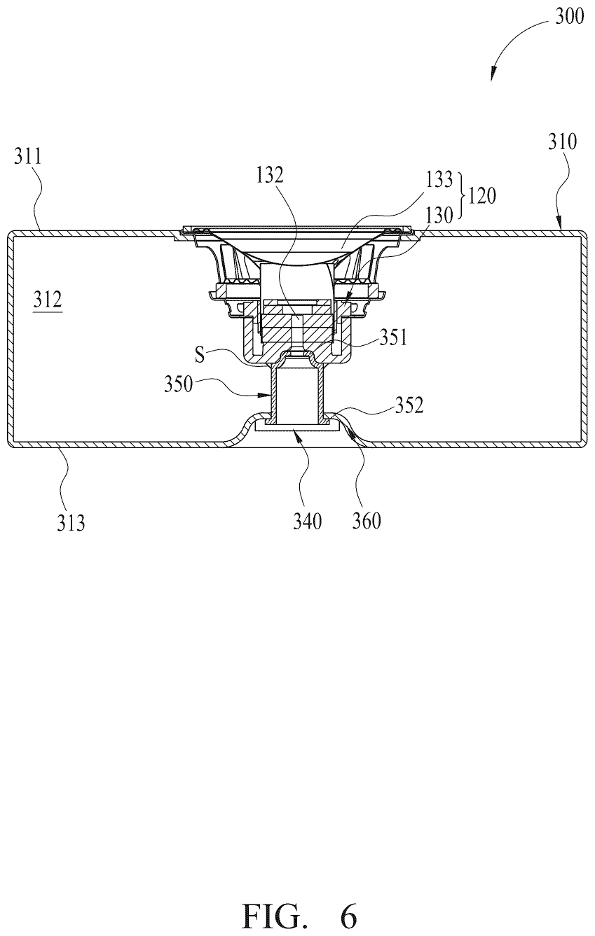

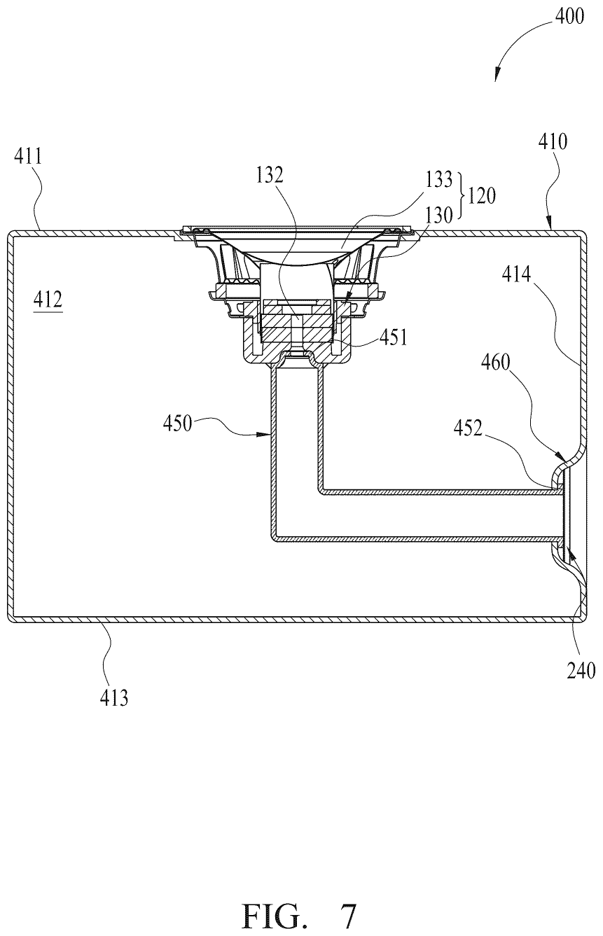

In another embodiment, as illustrated in FIGS. 5 and 6, a semi-permeable membrane assembly 340 is configured as a cap-like structure. In this embodiment, the extension tube 350 in an audio device 300 includes a first end 351 connected to the motor vent 132 and a second end 352 connected to an opening located in a recessed portion 360 of the enclosure 310. The acoustic transducer 120 may be mounted and sealed to a first opening on the first surface 311, and the recessed portion 360 is formed on the second surface 313 of the enclosure. 310. An annular support frame 342 of the semi-permeable membrane assembly 340 defines a central recessed portion corresponding in shape and size to the outer profile of the second end 352 of the extension tube 350. This allows the assembly to be sleeved over the second end 352, facilitating rapid and precise alignment during manufacturing.

A sealing material S may be disposed between the extension tube 350 and the magnetic motor assembly 130. This isolates the ventilation path from the internal volume 312. The sealing material S may comprise, for example, a adhesive material, a thermoplastic sealing ring, a liquid-applied sealant, an O-ring, a sealing ring, a rubber gasket, a foam gasket, or other components having elastic sealing properties, or any combination thereof, so as to provide airtight sealing. In some embodiments, the extension tube 350 may be secured to the magnetic motor assembly 130 by thermal riveting, ultrasonic welding, mechanical clamping, or other suitable fastening means, thereby reducing positional variation during installation and enhancing assembly stability.

Referring to FIG. 7, an audio device 400 according to another embodiment is illustrated. The audio device 400 includes an enclosure 410 and an extension tube 450 forming part of a ventilation structure. The extension tube 450 includes a first end 451 coupled to the motor vent 132 and a second end 452 positioned at a second opening formed in a recessed portion 460 of a side surface 414. The acoustic transducer 120 may be mounted and sealed to a first opening on the first surface 411, and the second opening is not formed on the second surface 413. The extension tube 450 is a curved conduit (e.g., L-shaped) extending toward the side surface 414 of the enclosure 410. The enclosure 410 defines a sealed internal volume 412. The curved conduit may allow flexible routing of the ventilation path within a compact enclosure while maintaining a sufficient airflow path length. The curved configuration may allow the ventilation path to be arranged within limited internal space of the enclosure while avoiding interference with other internal components.

In certain embodiments, the second end 452 of the extension tube 450 may include a flange extending radially outward from an outer periphery of the tube 450. Such a flange may facilitate mechanical engagement with the enclosure 410 or with the semi-permeable membrane assembly 240.

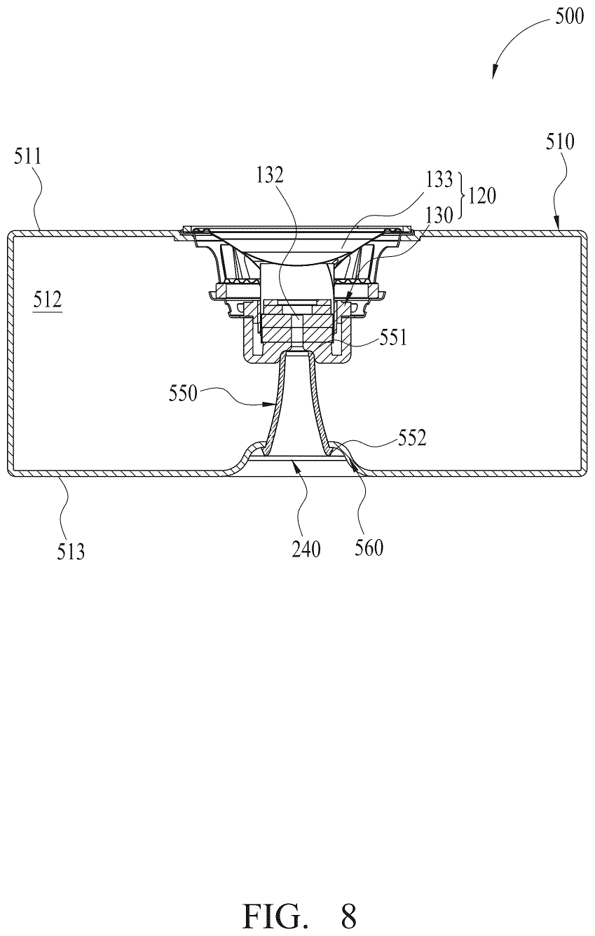

In another embodiment of an audio device 500 illustrated in FIG. 8, the extension tube 550 may include a flared or horn-shaped structure. The audio device 500 includes an enclosure 510 defining an internal volume 512. The acoustic transducer 120 is mounted and sealed to a first opening on the first surface 511, and a second opening is formed in a recessed portion 560 on a second surface 513. of the enclosure 510. In particular, at least a portion of an inner diameter of the extension tube 550 may gradually increase from the first end 551 toward the second end 552. This gradually expanding geometry may reduce flow resistance and may improve the efficiency of gas exchange. Additionally, the flared structure may reduce the possibility of acoustic turbulence that could otherwise affect sound quality. The flared section may reduce airflow resistance and minimize turbulence, thereby improving pressure equalization efficiency.

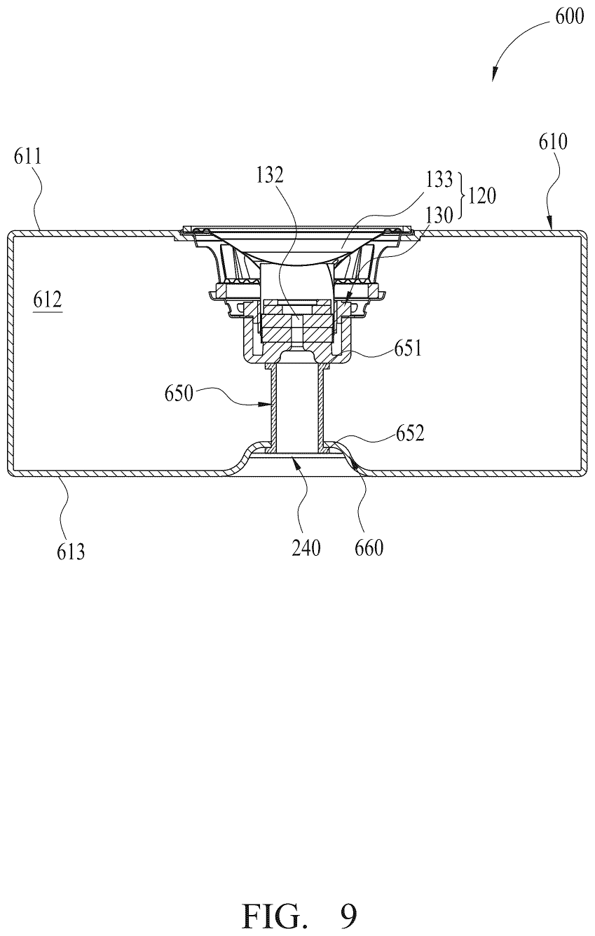

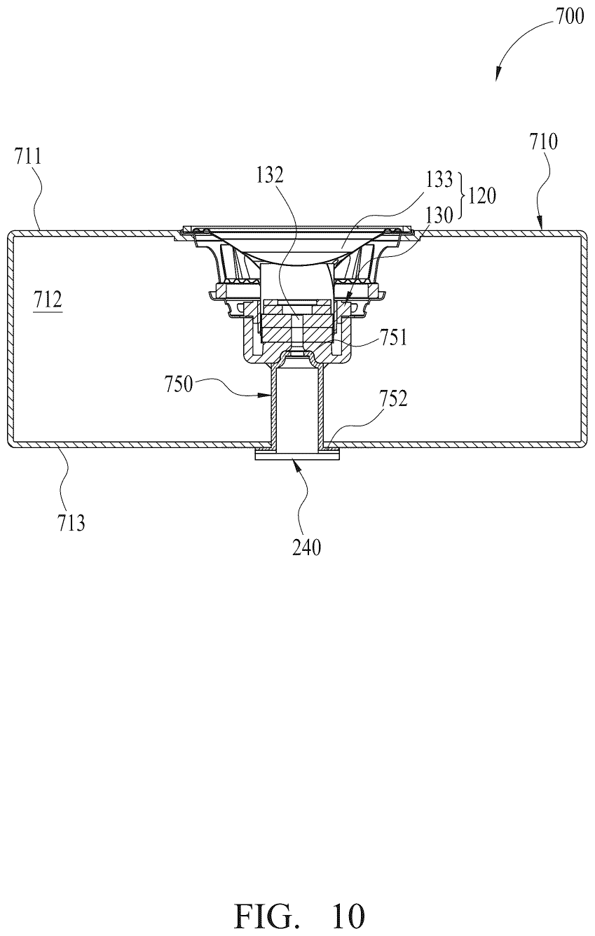

In another embodiment, as shown in FIG. 9, an audio device 600 includes an enclosure 610 defining an internal volume 612. The acoustic transducer 120 is mounted and sealed to a first opening on the first surface 611, and a second opening is formed in a recessed portion 660 on a second surface 613. of the enclosure 610. The first end 651 of the extension tube 650 does not include a protruding portion, but instead defines an outlet having substantially the same diameter as that of the second end 652, such that the extension tube 650 forms a straight-through conduit with a substantially uniform diameter along its longitudinal direction. The first end 651 and/or the second end 652 of the extension tube 650 further includes a flange portion, and the flange portion is directly secured to the magnetic motor assembly 130 and/or to the second opening of the enclosure 610. Through such direct attachment, the motor vent 132 is placed in direct gas communication with an interior passage of the extension tube 650, thereby simplifying the structural interface and reducing assembly complexity.

As shown in FIG. 10, yet another embodiment of the present disclosure is illustrated, wherein a structural configuration of the acoustic device 700 is generally similar to that of the embodiment shown in FIG. 4. The primary difference lies in that the enclosure 710 of the acoustic device 700 does not include the recessed portion described in the foregoing embodiments. Instead, a peripheral edge of the second opening on the second surface 713 of the enclosure 710 directly and sealingly surrounds an outer periphery of the extension tube 750, such that the outlet at the second end 752 is exposed and defined as the gas outlet of the ventilation structure. Similarly, the semi-permeable membrane assembly 240 may be directly secured to the second end 752 of the extension tube 750 to cover the outlet thereof. The acoustic transducer 120 is mounted and sealed to a first opening on the first surface 711 of the enclosure 710, The extension tube 750 includes a first end 751 coupled to the motor vent 132. In another embodiment, not shown in FIG. 10, the semi-permeable membrane assembly 240 may be embedded within the outlet of the second end 752 of the extension tube 750, or sleeved over the second end 752 of the extension tube 750, so as to permit controlled gas exchange between the sealed internal volume 712 and the external environment. By omitting the recessed portion of the enclosure 710, the present embodiment simplifies the molding structure of the enclosure 710 and reduces mold design and processing complexity, thereby improving manufacturability.

In some embodiments, the extension tube may be integrally molded with the enclosure, formed as a separate component and attached by adhesive or welding, or produced by insert molding.

In certain implementations, the ventilation structure described herein may be implemented as a modular component. Thus, a ventilation module is provided and may include: an extension conduit configured to connect to a motor vent of a magnetic motor assembly; and a semi-permeable membrane assembly disposed at an outlet of the extension conduit, wherein the semi-permeable membrane assembly permits gas exchange for pressure equalization while substantially preventing ingress of liquid and contaminants. The modular configuration may facilitate assembly and integration into various types of audio devices.

In certain implementations, a method for equalizing pressure in an audio device may include the following steps: providing an enclosure defining a sealed internal volume; mounting an acoustic transducer having a motor vent; forming a ventilation path from the motor vent to an exterior of the enclosure; and disposing a semi-permeable membrane at an outlet of the ventilation path. In operation, pressure differences between the sealed internal volume and the ambient environment are equalized through the ventilation path extending from the motor vent to the exterior opening. Gas may flow through the semi-permeable membrane, allowing pressure equalization while preventing ingress of liquid or contaminants.

By mounting the membrane assembly (140, 240, or 340) on non-moving components like the motor assembly 130 or extension tube (250, 350, 450, 550, 650, or 750), the moving mass of the diaphragm 133 remains unaffected, ensuring no loss in sound pressure level or sensitivity. During playback, the mechanical vibrations and air pulsations from the motor vent 132 act directly on the semi-permeable membrane (141 or 341). This helps dislodge accumulated water droplets or dust particles, maintaining clear ventilation over time.

In a multi-driver audio system in which multiple acoustic transducers are disposed within a common enclosure and arranged in respective chambers that are volumetrically isolated from one another, the foregoing ventilation structure may be selectively applied to one or more of the chambers. In such embodiments, each selected chamber is provided with a respective motor vent, extension tube, and semi-permeable membrane assembly configured to perform pressure equalization between the chamber and the external environment, while adjacent chambers remain acoustically isolated from one another. Such a configuration enables independent pressure balancing for individual acoustic transducers without compromising acoustic separation between the chambers, thereby maintaining intended acoustic performance characteristics of the multi-driver system.

According to the foregoing embodiments, the acoustic device disclosed herein achieves controlled gas exchange with the external environment by disposing a semi-permeable membrane assembly at a gas outlet of a ventilation structure, for example at an outlet of a motor vent or at an end outlet of an extension tube. In this manner, the sealed acoustic transducer is capable of performing controlled gas exchange with the external environment while preventing ingress of liquid, contaminants, or dust, thereby enabling gradual equalization of internal-to-external pressure differentials and enhancing acoustic operational stability.

Furthermore, by positioning the semi-permeable membrane assembly on a non-movable component of the acoustic transducer, any increase in moving mass of the diaphragm is avoided, thereby preserving acoustic sensitivity and reducing nonlinear distortion. In addition, airflow pulsations and mechanical vibrations generated during operation of the acoustic transducer may provide an auxiliary self-cleaning effect on the semi-permeable membrane, thereby reducing a risk of blockage within the ventilation structure and maintaining stable ventilation performance and environmental protection capability over prolonged use.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An audio device, comprising:
an enclosure defining a sealed internal volume and including a first opening formed on a first surface and a second opening formed on a second surface;
an acoustic transducer comprising a diaphragm and a magnetic motor assembly having a motor vent extending therethrough, the acoustic transducer being secured to the first opening such that the diaphragm is exposed through the first opening; and
a semi-permeable membrane assembly;
wherein a ventilation structure is defined by at least the motor vent and the second opening to establish gas communication between the sealed internal volume and an exterior of the enclosure, and the semi-permeable membrane assembly is positioned to traverse a gas outlet of the ventilation structure and is configured to permit gas exchange for pressure equalization while substantially blocking ingress of liquid and contaminants.

2. The audio device of claim 1, wherein a peripheral edge of the second opening sealingly surrounds an outer periphery of the magnetic motor assembly.

3. The audio device of claim 1, wherein the second surface of the enclosure comprises a recessed portion extending inwardly toward the magnetic motor assembly, and the second opening is formed on the recessed portion.

4. The audio device of claim 3, wherein a transverse cross-sectional inner diameter of the recessed portion gradually increases in an outward direction from the second opening.

5. The audio device of claim 1, further comprising an extension tube having a first end and a second end, wherein the first end of the extension tube is coupled to the motor vent and the second end of the extension tube is coupled to the second opening of the enclosure, such that the ventilation structure comprises at least a portion of the extension tube.

6. The audio device of claim 5, wherein the first end of the extension tube includes a protruding portion sleeved within or over the motor vent.

7. The audio device of claim 5, further comprising a sealing member disposed between the extension tube and the magnetic motor assembly.

8. The audio device of claim 5, wherein the extension tube is a curved conduit extending from the motor vent to the second opening.

9. The audio device of claim 5, wherein, in a transverse cross-section, at least a portion of an inner diameter of the extension tube gradually increases from the first end toward the second end, thereby forming a flared or horn-shaped tube.

10. The audio device of claim 5, wherein the second end of the extension tube includes a flange extending radially outward from an outer periphery of the extension tube for engagement with the enclosure or the semi-permeable membrane assembly.

11. The audio device of claim 1, wherein the semi-permeable membrane assembly comprises an annular support frame and a semi-permeable membrane secured within a central region of the annular support frame.

12. The audio device of claim 11, wherein the semi-permeable membrane assembly comprises a sealing member disposed on an outer periphery of the annular support frame or of the semi-permeable membrane.

13. The audio device of claim 11, wherein the annular support frame forms a cap structure having a central recessed portion corresponding in shape and size to the outer profile of the second end of the extension tube, and wherein the semi-permeable membrane assembly is sleeved over the second end.

14. The audio device according to claim 11, wherein the semi-permeable membrane comprises an expanded polytetrafluoroethylene (ePTFE) film or a functionally equivalent fluoropolymer film, and both opposing surfaces of the semi-permeable membrane are hydrophobic.

15. The audio device according to claim 11, wherein an outer surface of the semi-permeable membrane further includes a protective mesh or microporous overlay.

16. A ventilation module for an audio device comprising:
an extension conduit configured to connect to a motor vent of a magnetic motor assembly; and
a semi-permeable membrane assembly disposed at an outlet of the extension conduit,
wherein the semi-permeable membrane assembly permits gas exchange for pressure equalization while substantially preventing ingress of liquid and contaminants.

17. The ventilation module of claim 16, wherein the extension conduit includes a flared section.

18. The ventilation module of claim 16, wherein the semi-permeable membrane assembly comprises an annular support frame supporting a gas-permeable membrane.

19. The ventilation module of claim 16, wherein the extension conduit comprises a curved airflow channel.

20. A method of equalizing pressure in an audio device comprising:
providing an enclosure defining a sealed internal volume;
mounting an acoustic transducer having a motor vent;
forming a ventilation path from the motor vent to an exterior of the enclosure; and
disposing a semi-permeable membrane at an outlet of the ventilation path.
